(19) United States
(12) Patent Application Publication
(10) Pub. No.: US 2024/0174030 A1
(43) Pub. Date: May 30, 2024

(54) TIRE TREAD INCLUDING A DECOUPLING GROOVE

(71) Applicant: Bridgestone Americas Tire Operations, LLC, Nashville, TN (US)

(72) Inventors: Robert G. Barned, Akron, OH (US); Alek Shmagranoff, Akron, OH (US); Akiko Neil, Akron, OH (US); Cameron L. Reynolds, Akron, OH (US); Stephen T. Miranda, Akron, OH (US); Bradley S. Plotner, Akron, OH (US); Gregory Rasor, Akron, OH (US); Nicholas Harp, Akron, OH (US)

(21) Appl. No.: 18/553,280

(22) PCT Filed: Apr. 9, 2022
(86) PCT No.: PCT/US2022/024161

§ 371 Date: Sep. 29, 2023

Related U.S. Application Data
(60) Provisional application No. 63/176,022, filed on Apr. 16, 2021.

(51) Int. Cl. B60C 11/13; B60C 11/03; B60C 11/12

(52) U.S. Cl. CPC B60C 11/13; B60C 11/1236; B60C 2011/0353; B60C 2011/0355

(57) ABSTRACT

A tire including a decoupling groove is provided, the tire comprising: a body, a shoulder, a tread surface including at least one decoupling groove extending radially inwardly into the body from the tread surface, and a plurality of parallel sipes, wherein the decoupling groove is oriented adjacent to the shoulder, wherein the decoupling groove is defined by an axially outer groove sidewall and an axially inner groove sidewall, has a width W1, and has a centerline, wherein the plurality of parallel sipes extend axially into the inner groove sidewall, wherein the decoupling groove has a radially inner groove base defined by a curvilinear base surface, has a width W2, and has a center, wherein the width W2 is greater than the width W1, and wherein a centerline of the decoupling groove intersects the center of the groove base.

### CROSS-REFERENCE TO RELATED APPLICATIONS

This application claims priority from U.S. Provisional Patent Application No. 63/176,022, filed on Apr. 16, 2021, which is incorporated by reference herein in its entirety.

### BACKGROUND

Tires are consumable products. Particularly, as a tire is used on a road surface, and particularly on an asphalt road surface, the tire experiences wear in its tread region. Tires have a finite wear life in their tread region. One primary area of wear is the shoulder edge of the tire tread.

Extending the wear life of a tire is beneficial, not just from a cost perspective (in extending the life of the tire, the consumer gets more “miles per dollar”), but also from the standpoint of waste reduction. That is, extending the life of the tire ultimately decreases the number of tires a user consumes in the user's daily needs, and results in less tires having to be scrapped, recycled, or discarded to landfills.

One way to extend tire tread life (and particularly, shoulder edge tread wear) is to reduce the transfer of force from the tire casing to the wear surface as the casing deforms through the tire footprint.

Accordingly, what is needed is a tire tread feature to limit force transfer, pressure, and strain in the tire tread and thus extend the life of the tire tread.

### SUMMARY

In one aspect, a tire including a decoupling groove is provided, the tire comprising: a body, a shoulder, a tread surface including at least one decoupling groove extending radially inwardly into the body from the tread surface, and a plurality of parallel sipes, wherein the decoupling groove is oriented adjacent to the shoulder, wherein the decoupling groove is defined by an axially outer groove sidewall and an axially inner groove sidewall, has a width W1, and has a centerline, wherein the plurality of parallel sipes extend axially into the inner groove sidewall, wherein the decoupling groove has a radially inner groove base defined by a curvilinear base surface, has a width W2, and has a center, wherein the width W2 is greater than the width W1, and wherein a centerline of the decoupling groove intersects the center of the groove base.

In another aspect, a tire including a decoupling groove is provided, the tire comprising: a body, a shoulder, a tread surface including at least one decoupling groove extending radially inwardly into the body from the tread surface, and a plurality of parallel sipes, wherein the decoupling groove is oriented adjacent to the shoulder, wherein the decoupling groove is defined by an axially outer groove sidewall and an axially inner groove sidewall, has a width W1, and has a centerline, wherein the plurality of parallel sipes extend axially into the inner groove sidewall, wherein the decoupling groove has a radially inner groove base defined by a curvilinear base surface, has a width W2, and has a center, wherein the width W2 is greater than the width W1, wherein a centerline of the decoupling groove intersects the center of the groove base, wherein the tire has an axial axis A, a radial axis R, and a circumferential axis C, wherein the sipes are angled in a plane formed by the circumferential and axial axes, and wherein the sipes are angled in a plane formed by the circumferential and radial axes, wherein the sipes are angled by a sipe angle SA1 in the plane formed by the circumferential and axial axes, wherein the sipes are angled by a sipe angle SA2 in the plan formed by the circumferential and radial axes, wherein SA1 is between 20.0 degrees and 30.0 degrees from the axial axis A, and wherein SA2 is between 5.0 degrees and 15.0 degrees from the radial axis R.

### BRIEF DESCRIPTION OF THE DRAWINGS

The accompanying figures, which are incorporated in and constitute a part of the specification, illustrate various example aspects, and are used merely to illustrate various example aspects. In the figures, like elements bear like reference numerals.

FIG. 1 illustrates a perspective view of a tire 100 having a decoupling groove 108.

FIG. 2A illustrates a partial perspective view of a tire 200 having a decoupling groove 208.

FIG. 2B illustrates a partial perspective view of tire 200 having decoupling groove 208.

FIG. 3A illustrates a sectional view of a tire 300 having a decoupling groove 308.

FIG. 3B illustrates a sectional view of tire 300 having decoupling groove 308.

FIG. 3C illustrates a plan view of tire 300 having decoupling groove 308.

FIG. 3D illustrates a sectional view of tire 300 having decoupling groove 308.

FIG. 3E illustrates a sectional view of tire 300 having decoupling groove 308.

FIG. 3F illustrates a sectional view of tire 300 having decoupling groove 308.

FIG. 3G illustrates a sectional view of tire 300 having decoupling groove 308.

FIG. 4A illustrates a sectional view of a prior art tire 400 having decoupling groove 430.

FIG. 4B illustrates a strain graph of prior art tire 400 having decoupling groove 430.

FIG. 4C illustrates elevation views of a prior art tire 400 having decoupling groove 430.

FIG. 4D illustrates a wear energy graph of prior art tire 400 having decoupling groove 430.

FIG. 4E illustrates a wear energy intensity summary graph of prior art tire 400 having decoupling groove 430.

FIG. 5A illustrates a sectional view of tire 300 having decoupling groove 308.

FIG. 5B illustrates a strain graph of tire 300 having decoupling groove 308.

FIG. 5C illustrates elevation views of tire 300 having decoupling groove 308.

FIG. 5D illustrates a wear energy graph of tire 300 having decoupling groove 308.

FIG. 5E illustrates a wear energy intensity summary graph of tire 300 having decoupling groove 308.

FIG. 6A illustrates a shear force graph plotting the free rolling, fore-aft shear force of two tires.

FIG. 6B illustrates a shear force graph plotting the free rolling, lateral shear force of two tires.

FIG. 6C illustrates a shear force graph plotting the −2.5% lateral force, fore-aft shear force of two tires.

FIG. 6D illustrates a shear force graph plotting the −2.5% lateral force, lateral shear force of two tires.

### DETAILED DESCRIPTION

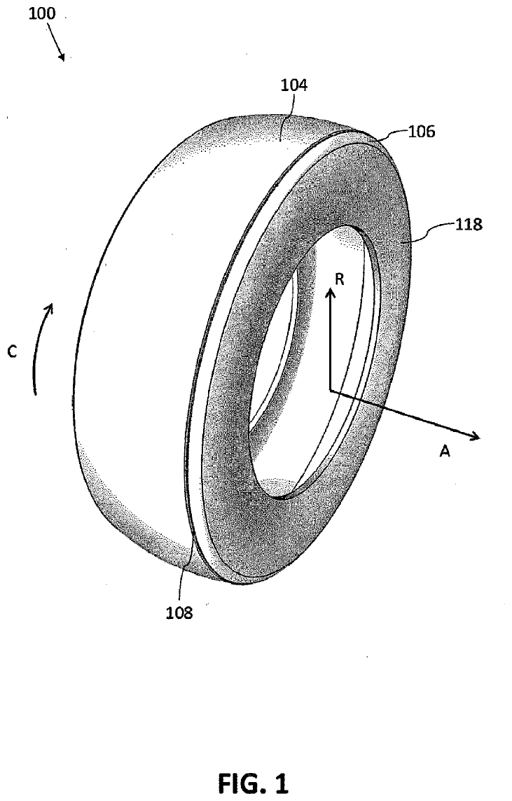

FIG. 1 illustrates a perspective view of a tire 100 having a decoupling groove 108. Tire 100 includes a tread surface 104, which is the radially outermost portion of the tire and that portion of the tire that contacts a roadway or other surface upon which the tire operates. Tire 100 includes a shoulder 106, which is a transition zone between tread 104 and the tire's sidewall 118.

As illustrated, tread surface 104 is featureless (except for decoupling groove 108). It is understood that such an arrangement is for simplicity in illustration only, and that in practice, tread surface 104 may include grooves forming ribs, grooves and slots forming tread blocks, and combinations thereof.

As illustrated, tire 100 includes an axial direction A, a circumferential direction C, and a radial direction R. Axial direction A is parallel to the axis of rotation of the tire. Circumferential direction C is parallel to the circumference of the tire. Radial direction R is parallel to the direction of radius of the tire.

Decoupling groove 108 may extend circumferentially completely around tire 100, and may extend radially inwardly from tread surface 104. Decoupling groove 108 may be oriented at axially outward portions of tread surface 104. Decoupling groove 108 may be oriented at one axially outward portion of tread surface 104. Decoupling groove 108 may be oriented at both axially outward portions of tread surface 104. “Axially outward” is understood to mean those portions of tread surface 104 outward from the centerline of tread surface 104.

Decoupling groove 108 may be oriented at one axially outwardmost portion of tread surface 104, at or near where tread surface 104 meets shoulder 106. Decoupling groove 108 may be oriented at both axially outwardmost portions of tread surface 104, at or near where tread surface 104 meets shoulder 106. This area, where tread surface 104 meets shoulder 106 may be referred to as the shoulder edge of tread surface 104. This portion or these portions of tread surface 104 form the lateral edges of tire 100's footprint when loaded to standard operating pressure.

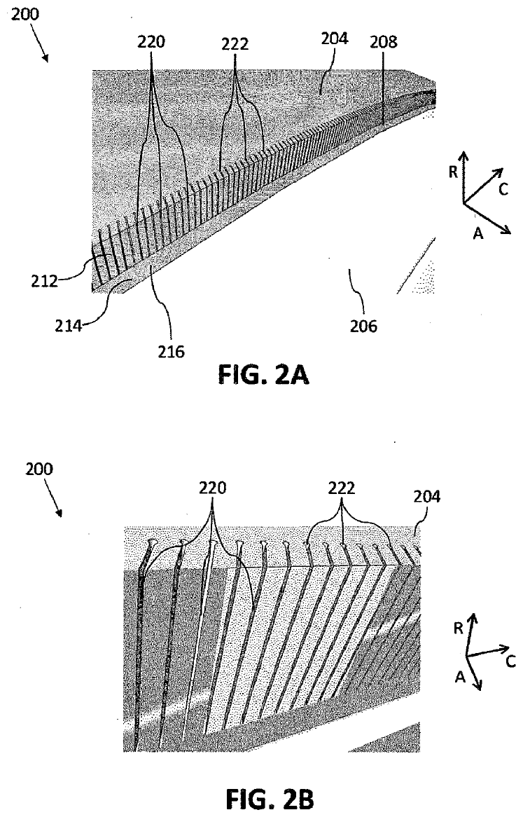

FIGS. 2A and 2B illustrate partial perspective views of a tire 200 having a decoupling groove 208. Tread surface 204 includes decoupling groove 208 oriented adjacent to, at, or near a shoulder 206. Decoupling groove 208 extends circumferentially.

Decoupling groove 208 includes an axially inner groove sidewall 212. Decoupling groove 208 includes a radially inner groove base 214 with a curvilinear base surface 216. As further described below, decoupling groove 208 and radially inner groove base 214 together form a keyhole shaped groove.

A plurality of parallel sipes 220 extend into groove sidewall 212. Sipes 220 are open to tread surface 204 and decoupling groove 208. Sipes 220 may include axially inner sipe bases 222. Sipes 220 extend substantially radially and axially, but may be biased from that plane as further described below.

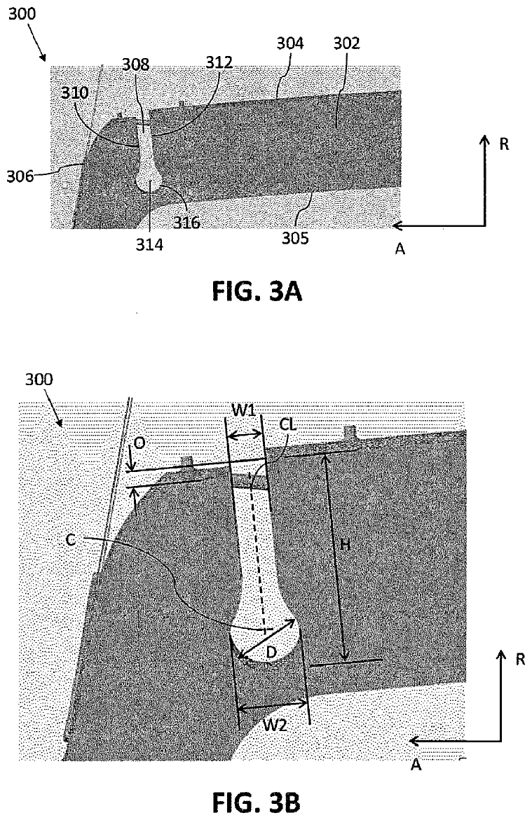

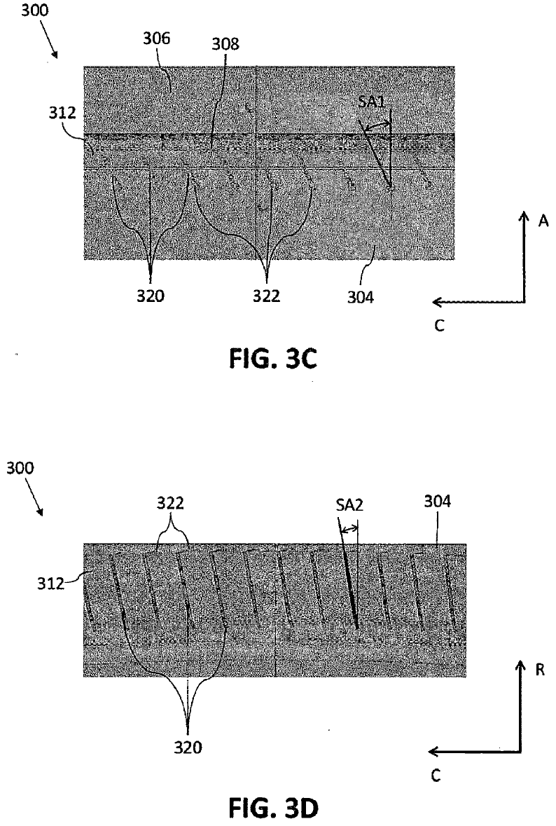

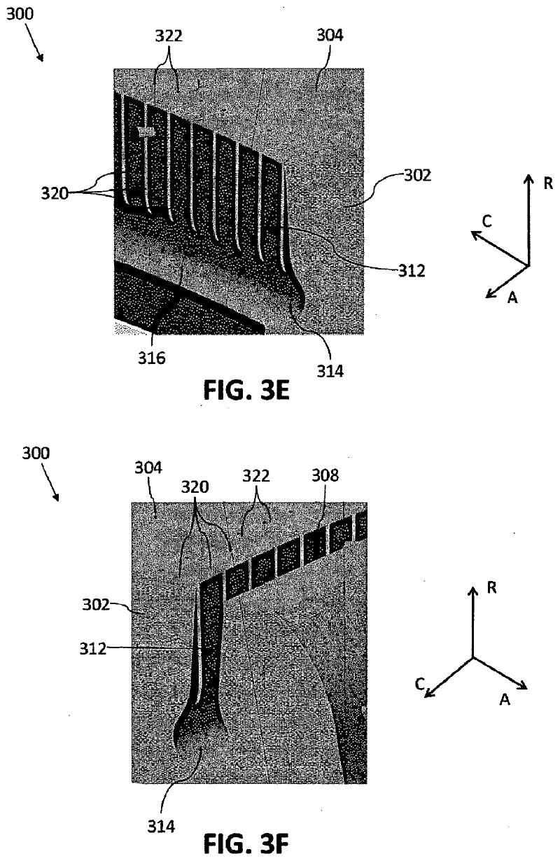

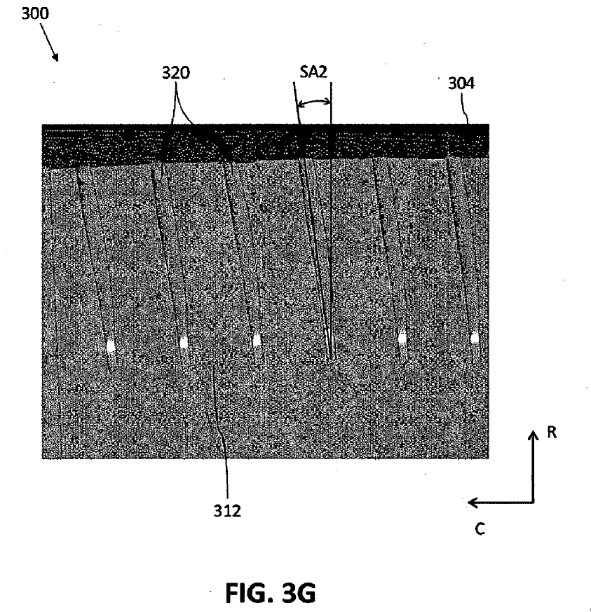

FIGS. 3A-3G illustrate a tire 300 having a decoupling groove 308. Tire 300 includes a body 302, having a tread surface 304 and an inner surface 305, and a shoulder 306.

Tire 300 includes a decoupling groove 308 extending radially inwardly from tread surface 304 adjacent to, at, or near shoulder 306. Decoupling groove 308 is defined by an axially outer groove sidewall 310 and an axially inner groove sidewall 312. Groove sidewalls 310 and 312 maybe parallel to one another. Decoupling groove includes a radially inner groove base 314 defined by a curvilinear base surface 316. Curvilinear base surface 316 may include part of a circle.

As illustrated in FIG. 3B, decoupling groove 308 has a width W1 defined as the width between axially outer groove sidewall 310 and axially inner groove sidewall 312. Width W1 is greater than about 2.0 mm. Width W1 is greater than 2.0 mm. Width W1 is about 2.5 mm. Width W1 is 2.5 mm. Width W1 is about 3.0 mm. Width W1 is 3.0 mm. Width W1 is between about 2.0 mm and about 3.0 mm. Width W1 is between 2.0 mm and 3.0 mm. Width W1 is about 3.5 mm. Width W1 is 3.5 mm. Width W1 is between about 2.0 mm and about 3.5 mm. Width W1 is between 2.0 mm and 3.5 mm. Decoupling groove 308 includes a centerline CL extending down the center of decoupling groove 308 between groove sidewall 310 and groove sidewall 312.

As illustrated in FIG. 3B, radially inner groove base 314 has a width W2 defined as the axial width. Groove base 314 may have a circular cross-section, and a diameter D, which is equal to width W2. Width W2 is about twice the value of width W1. Width W2 is twice the value of width W1. Width W2 may be 1.5 times the value of W1, 1.75 times the value, 2.0 times the value, 2.25 time the value, 2.5 times the value, 2.75 times the value, or 3.0 times the value. Width W2 is greater than about 4.0 mm. Width W2 is greater than 4.0 mm. Width W2 is about 5.0 mm. Width W2 is 5.0 mm. Width W2 is about 6.0 mm. Width W2 is 6.0 mm. Width W2 is between about 4.0 mm and about 6.0 mm. Width W2 is between 4.0 mm and 6.0 mm. Width W2 is about 7.0 mm. Width W2 is 7.0 mm. Width W2 is between about 4.0 mm and about 7.0 mm. Width W2 is between 4.0 mm and 7.0 mm. Base 314 may have a circular cross-section, and a center C. Centerline CL intersects center C. Alternatively, base 314 has an axial center point C halfway between the axially innermost and outermost sides of base 314, and centerline CL passes through that center point C.

As illustrated in FIG. 3B, decoupling groove 308 has a height H defined as the height between tread surface 304 axially inward of decoupling groove 308 and the radially innermost portion of groove base 314. Height H may be between about 7.0 mm and about 12.0 mm. Height H may be between 7.0 mm and 12.0 mm. Height H may be between about 8.0 mm and about 11.0 mm. Height H may be between 8.0 mm and 11.0. mm. Height H may be between about 8.15 mm and about 10.45 mm. Height H may be between 8.15 mm and 10.45 mm.

As illustrated in FIG. 3B, tread surface 304 may be radially offset from shoulder 306 by an offset distance O. Offset distance O may be about 0.5 mm, 1.0 mm, 1.5 mm, 2.0 mm, or 2.5 mm. Offset distance O may be between about 1.0 mm and about 2.0 mm. Offset distance O may be between about 0.5 mm and about 1.5 mm.

As illustrated in FIG. 3C, tire 300 includes a plurality of parallel sipes 320 extending into groove sidewall 312. Sipes 320 are open to tread surface 304 and decoupling groove 308. Sipes 320 may include axially inner sipe bases 322. Sipes 320 extend substantially radially and axially, but may be biased from that plane. Specifically, sipes 320 may be angled from axis A by a sipe angle SA1. Angle SA1 is an angle in the C-A plane. For clarity, angle SA1 is biased when looking down upon tread surface 304 from above. Angle SA1 may be about 25.0 degrees from the A axis. Angle SA1 may be 25.0 degrees from the A axis. Angle SA1 may be between about 20.0 degrees and about 30.0 degrees from the A axis. Angle SA1 may be between 20.0 degrees and 30.0 degrees from the A axis. Angle SA1 may be between about 15.0 degrees and about 35.0 degrees from the A axis. Angle SA1 may be between 15.0 degrees and 35.0 degrees from the A axis.

As illustrated in FIG. 3D, sipes 320 may be angled from axis R by a sipe angle SA2. Angle SA2 is an angle in the C-R plane. For clarity, angle SA2 is biased when looking at tread surface 304 from an axial side. Angle SA2 may be about 10.0 degrees from the R axis. Angle SA2 may be 10.0 degrees from the R axis. Angle SA2 may be between about 5.0 degrees and about 15.0 degrees from the R axis. Angle SA2 may be between 5.0 degrees and 15.0 degrees from the R axis. Angle SA2 may be between about 5.0 degrees and about 20.0 degrees from the A axis. Angle SA1 may be between 5.0 degrees and 20.0 degrees from the A axis.

Sipes 320 may be angled with both sipe angles SA1 and SA2 simultaneously. In another aspect, sipes 320 are angled with both sipe angles SA1 and SA2 simultaneously.

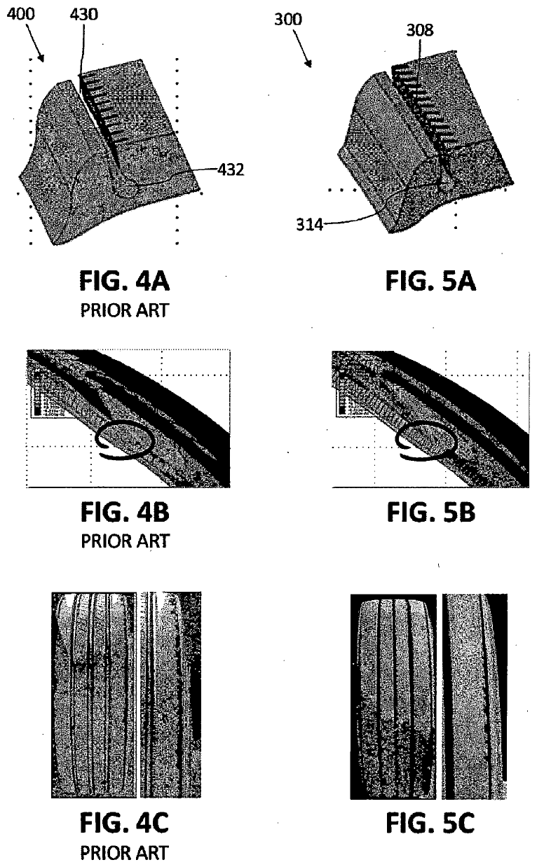

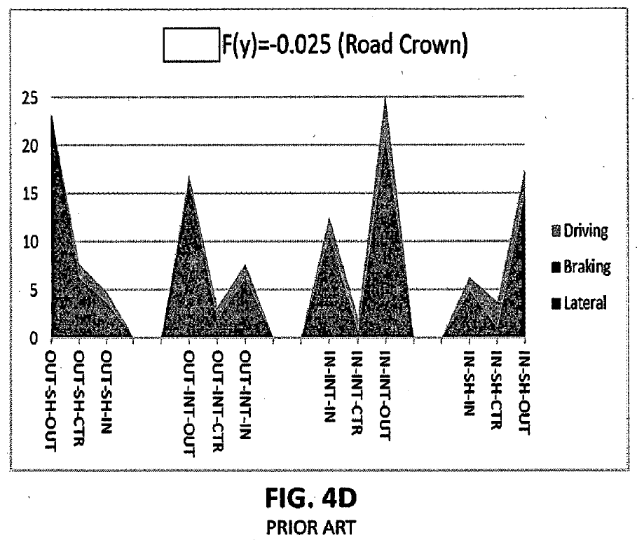

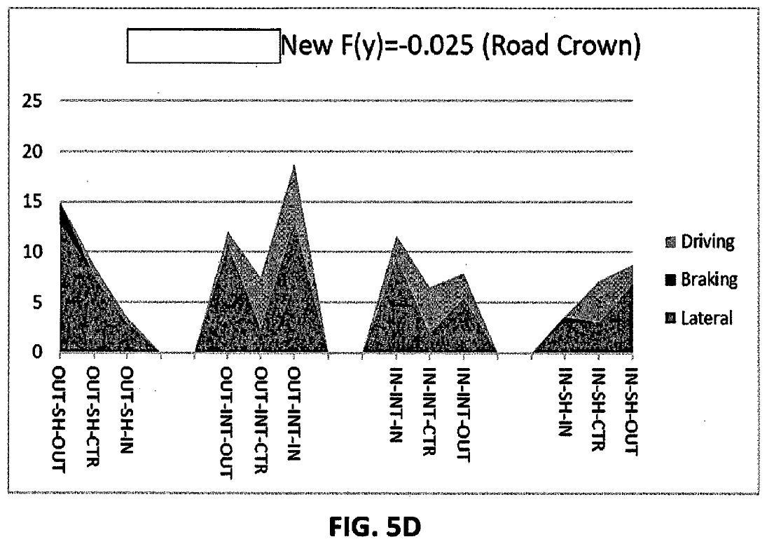

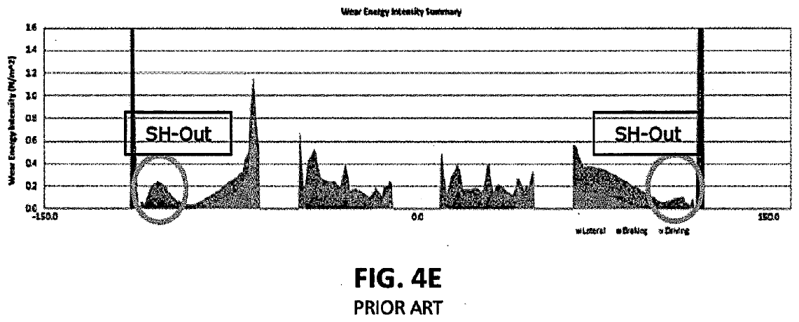

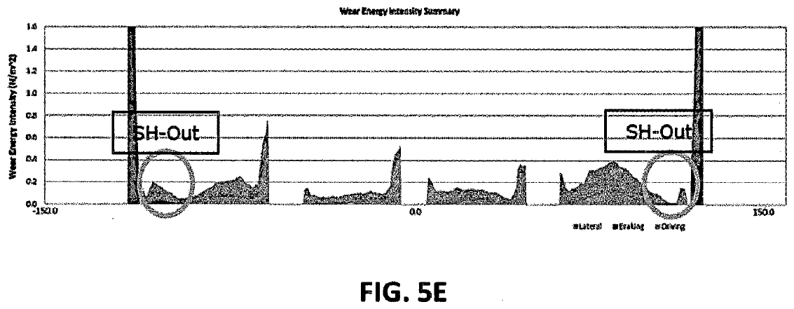

FIGS. 4A-4E illustrate images and graphs related to a prior art tire 400. FIGS. 5A-5E illustrate images and graphs related to tire 300 including decoupling groove 308. As illustrated in FIG. 4A, tire 400 includes a decoupling groove 430 having a groove base 432. Groove base 432 is axially offset from decoupling groove 430, such that the centerline of decoupling groove 430 does not intersect, or pass through, the center of groove base 432.

As illustrated in FIG. 5A, tire 300, on the other hand, includes decoupling groove 308 with a centerline that intersects the center of groove base 314, forming a keyhole shape, along with parallel sipes 320. This combination of the keyhole shape arrangement and parallel sipes 320 provides surprisingly good results as compared to the prior art (tire 400) that: (1) reduce stress concentration, (2) reduce variation in contact pressure across the wear surface (tread surface 304) by reducing pressure concentration at the tread edge (in the region of decoupling groove 308) caused by rubber compression, (3) reduce concentration of strain as the tread edge is deformed (in the region of decoupling groove 308), and/or (4) reduce concentration of strain at the radially inner portion of groove base 314 as body 302 and tread surface 304 deform, which increases resistance to tearing and/or cracking of the base surface 316. This combination of the keyhole groove base 314 in decoupling groove 308 and sipes 320 as discussed leads to increased resistance to irregular wear in tread surface 304. Additionally, the keyhole groove base 314 of decoupling groove 308 may remove contact pressure of tread surface 304.

FIG. 4B illustrates a strain graph of prior art tire 400 having decoupling groove 430. FIG. 5B illustrates a strain graph of tire 300 having decoupling groove 308. As illustrated, increased strain is experienced at the tread edge of tire 400 illustrated in the strain graph in FIG. 4B as compared to the strain graph in FIG. 5B.

FIG. 4C illustrates increased tread edge wear and tearing in the vicinity of decoupling groove 430. FIG. 5C, on the other hand, illustrates comparatively reduced tread edge wear and tearing in the vicinity of decoupling groove 308. Tires 300 and 400 were subjected to the same use and testing to generate the illustrated wear and tearing.

FIG. 4D illustrates a physical test wear energy graph of prior art tire 400 having decoupling groove 430. FIG. 5D illustrates a physical test wear energy graph of tire 300 having decoupling groove 308. A comparison of the two graphs illustrates that wear energy on the wear surface of tire 300 (FIG. 5D) is reduced/redistributed from the outer and inner shoulder shoulders (the leftmost and rightmost peaks) as compared to tire 400 (FIG. 4D). Further, as illustrated in FIG. 5D, the maximum wear energy experienced by tire 300 including decoupling groove 308 is more than 20% less than the maximum wear energy experienced by tire 400 including decoupling groove 430.

FIG. 4E illustrates a virtual test wear energy intensity summary graph of prior art tire 400 having decoupling groove 430. FIG. 5E illustrates a virtual test wear energy intensity summary graph of tire 300 having decoupling groove 308. A comparison of the two graphs illustrates that wear energy intensity on the wear surface of tire 300 (FIG. 5E) is reduced/redistributed from the outer and inner shoulder shoulders (the leftmost and rightmost peaks) as compared to tire 400 (FIG. 4E). Further, as illustrated in FIG. 5E, the maximum wear energy intensity experienced by tire 300 including decoupling groove 308 is more than 33% less than the maximum wear energy intensity experienced by tire 400 including decoupling groove 430.

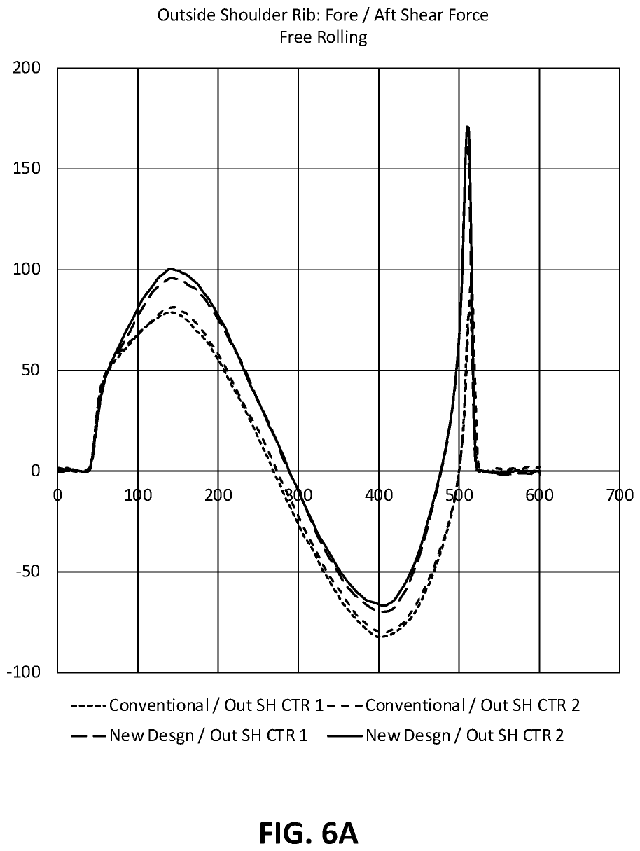

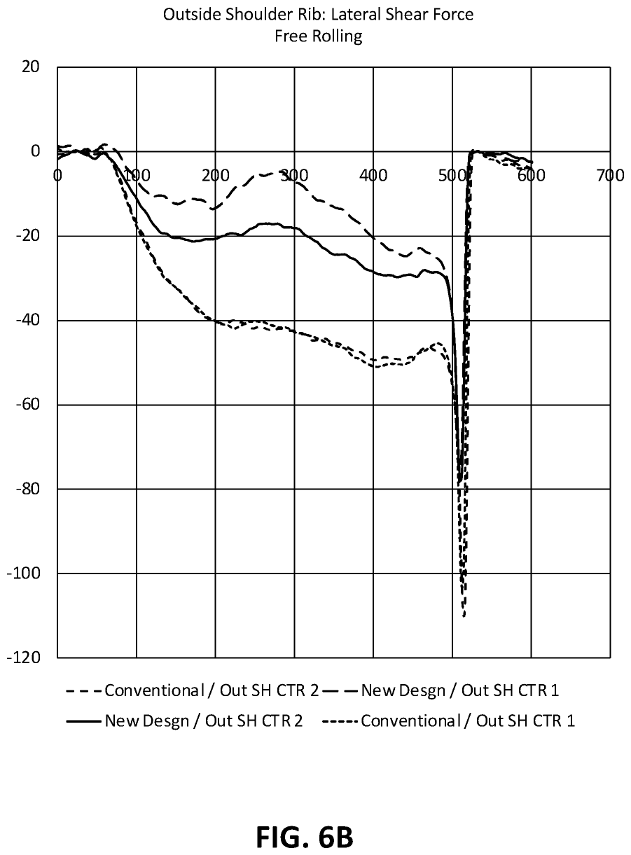

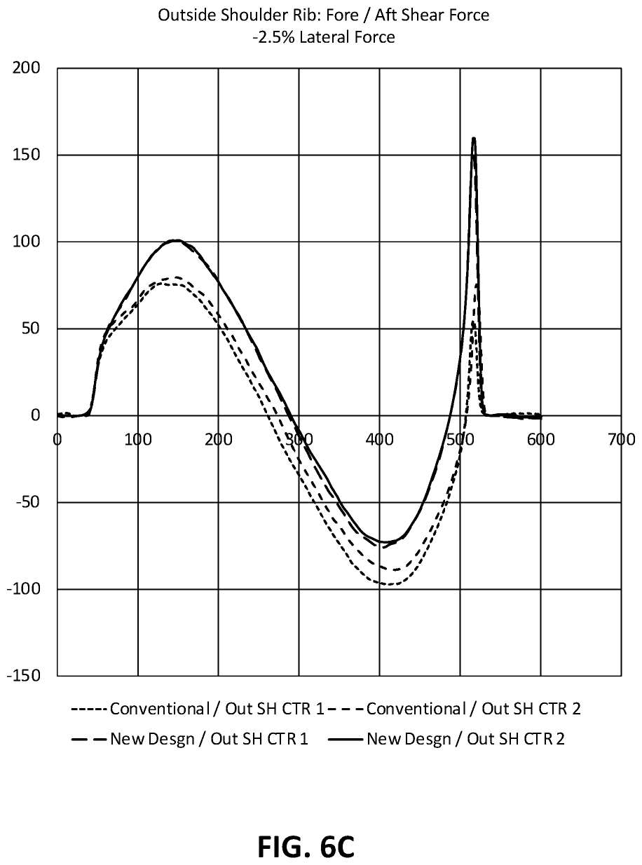

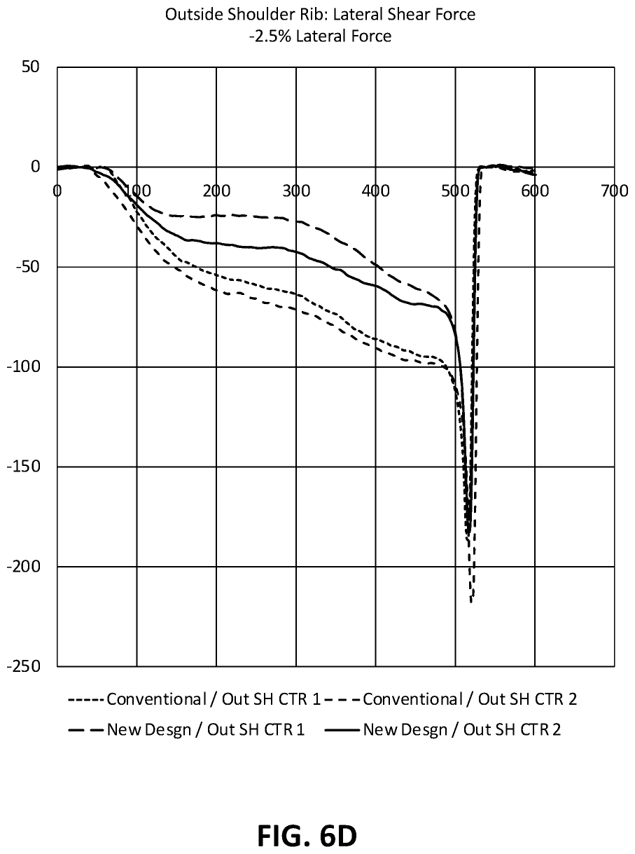

FIGS. 6A-6D illustrate shear force graph plotting the free rolling and −2.5% lateral force profiles of two tires. In each graph illustrated in FIGS. 6A-6D, it is desirable to shift the plots in the positive direction of the vertical axis (in other words, shift the plot vertically up) to increase the tire's irregular wear resistance. Stated differently, a plot shifted in the positive direction in the aforementioned graphs indicates a tire having an increased resistance to irregular wear, as opposed to a tire having a plot that is shifted in the negative (vertically down) direction, which would have a relatively lower resistance to regular wear.

The vertical axis of the plots illustrates the shear force, while the horizontal axis of the plots illustrates the position on the tire tested. Those portions of the plot in the extreme left and right ends (the negative-most and positive-most directions of the horizontal axis), where the value is shown as 0, are indicative of positions that are beyond the sensor's ability to detect shear force.

In each graph illustrated in FIGS. 6A-6D, the shear forces for the outside shoulder rib of the tires is the subject of the plots. The values shown correspond to shear forces at the axial center of each tire's outside shoulder rib, so as to provide a predicted average shear force across the subject shoulder rib.

FIG. 6A illustrates a shear force graph measuring the fore-aft (circumferential) shear force experienced in the outside shoulder rib of two tires. The shear force is measured in a free rolling scenario, where no lateral force is intentionally applied to the tire during testing. The two tires tested are the conventional tire (prior art tire 400) and the new design (tire 300). Fore-aft (circumferential) shear force for each of the conventional tire (400) and the new design (300) was measured twice, labeled “1” and “2” for each of tires 400 and 300. Fore-aft (circumferential) shear force for each of the conventional tire (400) and the new design (300) was measured in the center (that is, the axial center) of the outside shoulder rib of each tire.

As is illustrated, the new design plots (tire 300) are shifted in the positive direction (vertically up) relative to the conventional tire plots (tire 400). This vertical positive shift indicates that new design tire 300 has an improved or increased irregular wear resistance relative to the conventional tire 400.

FIG. 6B illustrates a shear force graph measuring the lateral (axial) shear force experienced in the outside shoulder rib of two tires. The shear force is measured in a free rolling scenario, where no lateral force is intentionally applied to the tire during testing. The two tires tested are the conventional tire (prior art tire 400) and the new design (tire 300). Lateral (axial) shear force for each of the conventional tire (400) and the new design (300) was measured twice, labeled “1” and “2” for each of tires 400 and 300. Lateral (axial) shear force for each of the conventional tire (400) and the new design (300) was measured in the center (that is, the axial center) of the outside shoulder rib of each tire.

As is illustrated, the new design plots (tire 300) are shifted in the positive direction (vertically up) relative to the conventional tire plots (tire 400). This vertical positive shift indicates that new design tire 300 has an improved or increased irregular wear resistance relative to the conventional tire 400.

FIG. 6C illustrates a shear force graph measuring the fore-aft (circumferential) shear force experienced in the outside shoulder rib of two tires. The shear force is measured with a −2.5% lateral force, where lateral force is intentionally applied to the tire during testing. The intent of applying the −2.5% lateral force is to replicate the lateral force that a tire experiences counteracting the road crown in the average roadway. That is, a driver may impart a small amount of steering angle to a vehicle's wheels, toward the road's crown, to maintain the vehicle's trajectory along the lane of travel. This steering angle is approximated by the −2.5% lateral force input The two tires tested are the conventional tire (prior art tire 400) and the new design (tire 300). Fore-aft (circumferential) shear force for each of the conventional tire (400) and the new design (300) was measured twice, labeled “1” and “2” for each of tires 400 and 300. Fore-aft (circumferential) shear force for each of the conventional tire (400) and the new design (300) was measured in the center (that is, the axial center) of the outside shoulder rib of each tire.

As is illustrated, the new design plots (tire 300) are shifted in the positive direction (vertically up) relative to the conventional tire plots (tire 400). This vertical positive shift indicates that new design tire 300 has an improved or increased irregular wear resistance relative to the conventional tire 400.

FIG. 6D illustrates a shear force graph measuring the lateral (axial) shear force experienced in the outside shoulder rib of two tires. The shear force is measured with a −2.5% lateral force, where lateral force is intentionally applied to the tire during testing, as described above with respect to FIG. 6C. The two tires tested are the conventional tire (prior art tire 400) and the new design (tire 300). Lateral (axial) shear force for each of the conventional tire (400) and the new design (300) was measured twice, labeled “1” and “2” for each of tires 400 and 300. Lateral (axial) shear force for each of the conventional tire (400) and the new design (300) was measured in the center (that is, the axial center) of the outside shoulder rib of each tire.

As is illustrated, the new design plots (tire 300) are shifted in the positive direction (vertically up) relative to the conventional tire plots (tire 400). This vertical positive shift indicates that new design tire 300 has an improved or increased irregular wear resistance relative to the conventional tire 400.

As evidenced by the graphs of FIGS. 6A-6D, the combination of the keyhole groove base 314 in decoupling groove 308, and sipes 320, leads to increased resistance to irregular wear in tread surface 304 of tire 300 relative to conventional tire 400.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available in tire manufacturing. To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of embodiments and aspects thereof, and while the embodiments and aspects have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

What is claimed is:

1. A tire including a decoupling groove, comprising:
a body,
a shoulder,
a tread surface including at least one decoupling groove extending radially inwardly into the body from the tread surface, and
a plurality of parallel sipes,
wherein the decoupling groove is oriented adjacent to the shoulder,
wherein the decoupling groove is defined by an axially outer groove sidewall and an axially inner groove sidewall, has a width W1, and has a centerline,
wherein the plurality of parallel sipes extend axially into the inner groove sidewall,
wherein the decoupling groove has a radially inner groove base defined by a curvilinear base surface, has a width W2, and has a center,
wherein the width W2 is greater than the width W1, and
wherein a centerline of the decoupling groove intersects the center of the groove base.

2. The tire of claim 1, wherein the tire has an axial axis A, a radial axis R, and a circumferential axis C, and wherein the sipes are angled in a plane formed by the circumferential and axial axes.

3. The tire of claim 2, wherein the sipes are angled by a sipe angle SA1, and
wherein SA1 is 25.0 degrees from the axial axis A.

4. The tire of claim 2, wherein the sipes are angled by a sipe angle SA1, and
wherein SA1 is between 20.0 degrees and 30.0 degrees from the axial axis A.

5. The tire of claim 1, wherein the tire has an axial axis A, a radial axis R, and a circumferential axis C, and wherein the sipes are angled in a plane formed by the circumferential and radial axes.

6. The tire of claim 5, wherein the sipes are angled by a sipe angle SA2, and
wherein SA2 is 10.0 degrees from the radial axis R.

7. The tire of claim 5, wherein the sipes are angled by a sipe angle SA2, and
wherein SA2 is between 5.0 degrees and 15.0 degrees from the radial axis R.

8. The tire of claim 1, wherein the tire has an axial axis A, a radial axis R, and a circumferential axis C, wherein the sipes are angled in a plane formed by the circumferential and axial axes, and wherein the sipes are angled in a plane formed by the circumferential and radial axes.

9. The tire of claim 8, wherein the sipes are angled by a sipe angle SA1 in the plane formed by the circumferential and axial axes, wherein the sipes are angled by a sipe angle SA2 in the plan formed by the circumferential and radial axes, wherein SA1 is 25.0 degrees from the axial axis A, and wherein SA2 is 10.0 degrees from the radial axis R.

10. The tire of claim 1, wherein the width W1 is 2.5 mm.

11. The tire of claim 1, wherein the width W1 is greater than 2.0 mm.

12. The tire of claim 1, wherein the width W2 is 2.0 times the value of the width W1.

13. The tire of claim 1, wherein the groove base comprises circular cross-section having a diameter D, and wherein the diameter D is equal to the width W2.

14. The tire of claim 1, wherein the sipes are open to the tread surface and the decoupling groove.

15. A tire including a decoupling groove, comprising:
a body,
a shoulder,
a tread surface including at least one decoupling groove extending radially inwardly into the body from the tread surface, and
a plurality of parallel sipes,
wherein the decoupling groove is oriented adjacent to the shoulder,
wherein the decoupling groove is defined by an axially outer groove sidewall and an axially inner groove sidewall, has a width W1, and has a centerline,
wherein the plurality of parallel sipes extend axially into the inner groove sidewall,
wherein the decoupling groove has a radially inner groove base defined by a curvilinear base surface, has a width W2, and has a center,
wherein the width W2 is greater than the width W1,
wherein a centerline of the decoupling groove intersects the center of the groove base,
wherein the tire has an axial axis A, a radial axis R, and a circumferential axis C,
wherein the sipes are angled in a plane formed by the circumferential and axial axes, and wherein the sipes are angled in a plane formed by the circumferential and radial axes,
wherein the sipes are angled by a sipe angle SA1 in the plane formed by the circumferential and axial axes,
wherein the sipes are angled by a sipe angle SA2 in the plan formed by the circumferential and radial axes,
wherein SA1 is between 20.0 degrees and 30.0 degrees from the axial axis A, and
wherein SA2 is between 5.0 degrees and 15.0 degrees from the radial axis R.

16. The tire of claim 15, wherein SA1 is 25.0 degrees from the axial axis A.

17. The tire of claim 15, wherein SA2 is 10.0 degrees from the radial axis R.

18. The tire of claim 15, wherein the width W1 is 2.5 mm.

19. The tire of claim 15, wherein the width W2 is 2.0 times the value of the width W1.

20. The tire of claim 15, wherein the groove base comprises circular cross-section having a diameter D, and wherein the diameter D is equal to the width W2.
